(19) United States
(12) Patent Application Publication
(10) Pub. No.: US 2026/0053092 A1
(43) Pub. Date: Feb. 26, 2026

(54) SYSTEM AND METHOD FOR AN AGRICULTURAL VEHICLE

(71) Applicants: CNH Industrial Brasil Ltda., Nova Lima (BR); CNH INDUSTRIAL BELGIUM N.V., Zedelgem (BE)

(72) Inventors: Andre Satoshi Seki, Nova Lima (BR); Marcos Ikeguchi Ohira, Nova Lima (BR); Rafael Gazeta De Oliveira, Nova Lima (BR); Bart M.A. Missotten, Zedelgem (BE); Yuanyuan Li, Zedelgem (BE); Arthur Weschenfelder D'avila, Florianópolis (BR); Feres Azevedo Salem, Florianópolis (BR); Rivael Pigatto, Florianópolis (BR); Sidney Roberto Dias De Carvalho, Florianópolis (BR)

(21) Appl. No.: 19/308,902

(22) Filed: Aug. 25, 2025

(30) Foreign Application Priority Data
Aug. 26, 2024 (BR) 10 2024 017475 5

(51) Int. Cl. A01D 34/00; A01D 45/10

(52) U.S. Cl. CPC A01D 45/10

(57) ABSTRACT

A system for an agricultural vehicle includes a base cutter assembly operably coupled with a frame. A vehicle height control system may be configured to alter a position of the base cutter assembly. A sensor system may include a first field sensor configured to capture terrain data associated with a terrain of the field. A computing system may be configured to receive an input related to a defined offset of the base cutter assembly relative to the field, receive the terrain data from the sensor system, determine a terrain variation of the field based on the terrain data, determine a detected position of the base cutter assembly relative to the field based on the detected terrain variation, and actuate the vehicle height control system based on a variation between a defined height of the base cutter assembly and a detected height of the base cutter assembly.

### FIELD OF THE INVENTION

The present disclosure relates generally to agricultural vehicles, such as sugarcane vehicles, and, more particularly, to systems and methods for a topper assembly of the agricultural vehicle.

### BACKGROUND OF THE INVENTION

In some cases, agricultural vehicles include an assembly of processing components for processing harvested material. For instance, within a sugarcane vehicle, a topper assembly can remove an upper portion of the sugar cane crop. The remaining sugarcane stalks may then be conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

During the operation of the vehicle, terrain variations may affect an amount of harvested material. Accordingly, systems and methods for monitoring terrain variations would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural vehicle. The system includes a base cutter assembly operably coupled with a frame. The base cutter assembly is configured to sever a crop in a field. A vehicle height control system is configured to alter a position of the base cutter assembly. A sensor system includes a first field sensor configured to capture terrain data associated with a terrain of the field. A computing system includes one or more processors and one or more non-transitory computer-readable media that collectively store instructions that, when executed by the one or more processors, configure the computing system to perform operations. The operations include receiving an input related to a defined offset of the base cutter assembly relative to the field, receiving the terrain data from the sensor system, determining a terrain variation of the field based on the terrain data, determining a detected position of the base cutter assembly relative to the field based on the detected terrain variation, and actuating the vehicle height control system based on a variation between a defined height of the base cutter assembly and a detected height of the base cutter assembly.

In some aspects, the present subject matter is directed to a computer-implemented method for agricultural harvesting. The computer-implemented method includes receiving an input related to a defined offset of a base cutter assembly relative to a field. The method also includes receiving, from a sensor system, terrain data of the field. The method further includes determining, with a computing system, a terrain variation of the field based on the terrain data. The method further includes determining a detected position of the base cutter assembly relative to the field based on the detected terrain variation. Lastly, the method includes actuating a vehicle height control system based on a variation between a defined height of a base cutter assembly and a detected position of the base cutter assembly relative to the field.

In some aspects, the present subject matter is directed to system for an agricultural vehicle. The system includes a base cutter assembly operably coupled with a frame. The base cutter assembly is configured to sever a crop in a field. A vehicle height control system includes a height control actuator configured to alter a position of the base cutter assembly and the frame relative to a tractive assembly. A sensor system includes a first field sensor configured to capture data indicative of a first set of terrain data and a vehicle height control sensor configured to detect a position of the height control actuator. A computing system includes one or more processors and one or more non-transitory computer-readable media that collectively store instructions that, when executed by the one or more processors, configure the computing system to receive an input related to a defined offset, receive data from the sensor system, determine a detected position of the base cutter assembly relative to the field based on the position of the height control actuator, determine a terrain variation based on data from the first field sensor, and actuate the vehicle height control system based on a variation between a defined height of the base cutter assembly and a detected height of the base cutter assembly.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural vehicle in accordance with aspects of the present subject matter;

FIG. 2 illustrates a side view of a portion of the vehicle having a topper assembly within a field in accordance with aspects of the present subject matter;

FIG. 3 illustrates a side view of the agricultural vehicle in accordance with aspects of the present subject matter;

FIG. 4 illustrates a bottom perspective view of the agricultural vehicle in accordance with aspects of the present subject matter;

FIG. 5 illustrates a partial side view of the agricultural vehicle in accordance with aspects of the present subject matter;

FIG. 6 illustrates a schematic view of a system for a harvesting operation in accordance with aspects of the present subject matter;

FIG. 7 is a schematic block diagram illustrating portions of the computing system within the agricultural applicator system in accordance with aspects of the present subject matter;

FIG. 8 illustrates a side view of the agricultural vehicle in accordance with aspects of the present subject matter;

FIG. 9 illustrates a side view of the agricultural vehicle in accordance with aspects of the present subject matter;

FIG. 10 illustrates a side view of the agricultural vehicle in accordance with aspects of the present subject matter;

FIG. 11 illustrates a side view of the agricultural vehicle in accordance with aspects of the present subject matter;

FIG. 12 illustrates a rear view of the agricultural vehicle in accordance with various aspects of the present subject matter;

FIG. 13 illustrates a rear view of the agricultural vehicle in accordance with various aspects of the present subject matter; and

FIG. 14 illustrates a flow diagram of a method for a harvesting operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the defined functionality is achieved, irrespective of architectures or intermedial components. Likewise, any two components so associated can also be viewed as being “operably connected” or “operably coupled” to each other to achieve the defined functionality, and any two components capable of being so associated can also be viewed as being “operably couplable” to each other to achieve the defined functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for agricultural vehicles. The system may include a base cutter assembly operably coupled with a frame. The base cutter assembly may be configured to sever a crop in a field. A vehicle height control system may be configured to alter a position of the base cutter assembly. A sensor system includes a first field sensor configured to capture a first set of terrain data associated with a terrain of the field and, possibly, a second field sensor configured to capture a second set of terrain data associated with a terrain of the field. The second field sensor may be positioned aft of the first field sensor.

A computing system may be configured to receive an input related to a defined offset or height of the base cutter assembly 50 relative to the field F, receive the terrain data from the first field sensor and/or the second field sensor, determine a terrain variation of the field based on the first set of terrain data and/or the second set of terrain data, determine a detected position of the base cutter assembly relative to the field based on the detected terrain variation, the position of the height control actuator, and/or any other source. In turn, the computing system may actuate the vehicle height control system based on a variation between the defined height of the base cutter assembly and a detected height of the base cutter assembly.

As used herein, a terrain variation may be defined as a height variation in a vehicle fore-aft direction, a lateral direction perpendicular to the fore aft-direction, a vehicle bottom to top direction that may be perpendicular to fore-aft direction and/or the lateral direction, a combination thereof, and/or any other direction. As such, the terrain variation may be a ridge, a valley, and/or any other variation that may occur within a field.

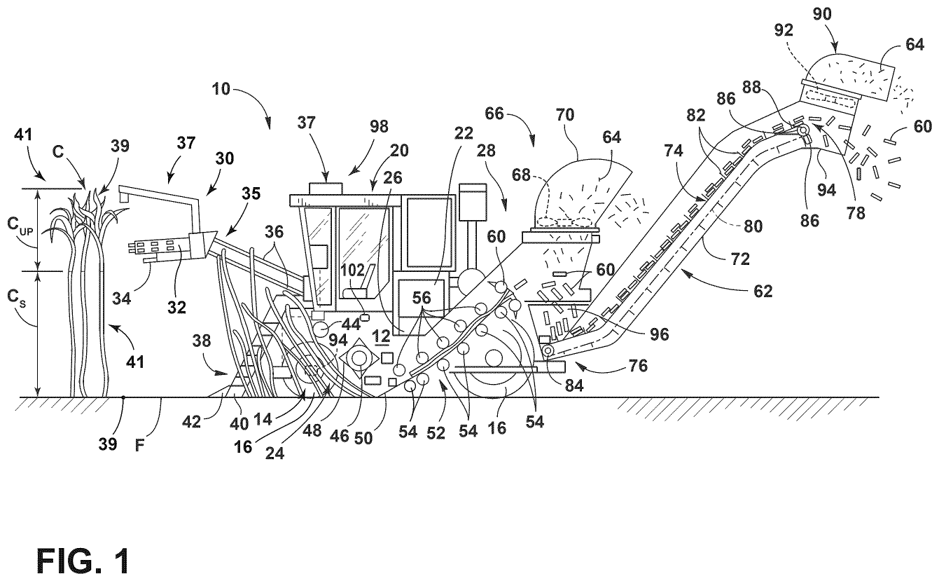

Referring now to the drawings, FIG. 1 illustrates a side view of an agricultural vehicle 10 in accordance with aspects of the present subject matter. As shown, the vehicle 10 may be configured as a sugarcane harvester. The sugarcane may include an upper portion Cᵤₚ that includes one or more leaves and a stalk Cₛ below the upper portion Cᵤₚ. It will be appreciated that, in other examples, the vehicle 10 may correspond to any other suitable agricultural vehicle capable of performing any operation without departing from the teachings provided herein.

As shown in FIG. 1, the vehicle 10 can include a frame 12, a tractive assembly 14, such as a pair of front wheels 16 and a pair of rear wheels 16 and/or a pair of tracks 18, and an operator's cab 20. The vehicle 10 may also include a power source 22 (e.g., an engine mounted on the frame 12) that powers the tractive assembly 14, which may include wheels 16, and/or tracks 18, via a driveline assembly 24 (e.g., a transmission) to traverse a field F. The power source 22 may also drive a hydraulic fluid pump 26 to power various components of the vehicle 10, including the driveline assembly 24.

The vehicle 10 may also include a harvested material processing system 28 incorporating various components, assemblies, and/or sub-assemblies of the vehicle 10 for cutting, processing, cleaning, and discharging sugarcane as the stalk Cₛ is harvested from an agricultural field F. For instance, the harvested material processing system 28 may include a topper assembly 30 positioned at the front-end portion of the vehicle 10 to intercept sugarcane as the vehicle 10 is moved in a forward direction. As shown, the topper assembly 30 may include a gathering disk 32 and/or a cutting disk 34. The gathering disk 32 may be configured to gather the sugarcane stalks Cₛ so that the cutting disk 34 may be used to cut off an upper portion Cᵤₚ of each stalk Cₛ. The height of the topper assembly 30 may be adjustable, which may be raised and lowered by an adjustment assembly 35 that may be hydraulically powered by the hydraulic fluid pump 26 and/or through any other manner (e.g., electrically powered, mechanically powered, manually adjusted, etc.). In some examples, the adjustment assembly 35 may include a pair of arms 36 for adjusting a height of the topper assembly 30. Additionally or alternatively, the adjustment assembly 35 may allow for the arms 36 and the topper assembly 30 to rotate relative to the frame 12 of the vehicle 10 and/or the topper assembly 30 to rotate relative to the arms 36.

The harvested material processing system 28 may also include a sensor system 37 that is configured to capture data associated with the crop C. Based on the data, the adjustment assembly 35 may alter the height of the topper assembly 30. For example, in some cases, the sensor system 37 may capture data indicative of a target 39 associated with the crop C and/or an object 41 proximate to the vehicle 10. Based on the position of the target 39, the adjustment assembly 35 may alter the height of the topper assembly 30 so that a generally common upper portion Cᵤₚ height may be removed from each of the crops C harvested by the vehicle 10. As described in more detail below, the sensor system 37 may further be configured to capture data indicative of a terrain of the agricultural field F.

The harvested material processing system 28 may further include a harvested material divider 38. In general, the harvested material divider 38 may include one or more spiral feed rollers 40. Each feed roller 40 may include a ground shoe 42 at its lower end portion to assist the harvested material divider 38 in gathering the sugarcane stalks Cₛ for harvesting.

Moreover, as shown in FIG. 1, the harvested material processing system 28 may include a knock-down roller 44 positioned near the tractive assembly 14 and a fin roller 46 positioned behind the knock-down roller 44. As the knock-down roller 44 is rotated, the sugarcane stalks Cₛ being harvested are knocked down while the harvested material divider 38 gathers the stalks Cₛ from agricultural field F. Further, as shown in FIG. 1, the fin roller 46 may include a plurality of intermittently mounted fins 48 that assist in forcing the sugarcane stalks Cₛ downward. As the fin roller 46 is rotated during the harvest, the sugarcane stalks Cₛ that have been knocked down by the knock-down roller 44 are separated and further knocked down by the fin roller 46 as the vehicle 10 continues to be moved in the forward direction relative to the field F.

Referring still to FIG. 1, the harvested material processing system 28 of the vehicle 10 may also include a base cutter assembly 50 positioned behind the fin roller 46. The base cutter assembly 50 may include blades for severing the sugarcane stalks Cₛ as the sugarcane is being harvested. The blades, which may be located on a periphery section of the base cutter assembly 50, may be rotated by a hydraulic circuit.

Moreover, the harvested material processing system 28 may include a feed roller assembly 52 located downstream of the base cutter assembly 50 for moving the severed stalks Cₛ of sugarcane from base cutter assembly 50 along the processing path of the harvested material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris (e.g., rocks, dirt, and/or the like) may be allowed to fall through bottom rollers 54 onto the field F.

In addition, the harvested material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks Cₛ into pieces or “billets” 60, which may be, for example, six (6) inches long. The billets 60 may then be propelled towards an elevator assembly 62 of the harvested material processing system 28 for delivery to an external receiver or storage device.

The pieces of debris 64 (e.g., dust, dirt, leaves, etc.) separated from the sugarcane billets 60 may be expelled from the vehicle 10 through a primary extractor 66 of the harvested material processing system 28, which may be located downstream of the chopper assembly 58 and may be oriented to direct the debris 64 outwardly from the vehicle 10. Additionally, an extractor fan 68 may be mounted within an extractor housing 70 of the primary extractor 66 for generating a suction force or vacuum sufficient to force the debris 64 through the primary extractor 66. The separated or cleaned billets 60, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60 on the elevator 74 as the sugarcane billets 60 are elevated along a top span of the elevator 74 defined between its proximal and distal end portions 76, 78. Additionally, the elevator 74 may include lower and upper sprockets 84, 86 positioned at its proximal and distal end portions 76, 78, respectively. As shown in FIG. 1, an elevator motor 88 may be coupled to one of the sprockets (e.g., the upper sprocket 86) for driving the chain 80, thereby allowing the chain 80 and the paddles 82 to travel in a loop between the proximal and distal end portions 76, 78 of the elevator 74.

Moreover, in some examples, pieces of debris 64 (e.g., dust, dirt, leaves, etc.) separated from the elevated sugarcane billets 60 may be expelled from the vehicle 10 through a secondary extractor 90 of the harvested material processing system 28 coupled to the rear end portion of the elevator housing 72. For example, the debris 64 expelled by the secondary extractor 90 may be debris 64 remaining after the billets 60 are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the vehicle 10. Additionally, an extractor fan 92 may be mounted at the base of the secondary extractor 90 to generate a suction force or vacuum sufficient to force the debris 64 through the secondary extractor 90. The separated, cleaned billets 60, heavier than the debris 64 expelled through the primary extractor 66, may then fall from the distal end portion 78 of the elevator 74. In some instances, the billets 60 may fall downwardly into an elevator discharge opening 94 defined by the elevator assembly 62 into an external storage device, such as a sugarcane billet cart.

During operation, the vehicle 10 traverses the agricultural field F for harvesting sugarcane and receives data related to one or more targets 39 associated with the approaching crop C. Based at least partially on the one or more targets 39 (and/or any other input), the height of the topper assembly 30 is adjusted via the adjustment assembly 35. With the topper assembly 30 positioned in a defined position, the gathering disk 32 on the topper assembly 30 may function to gather the sugarcane stalks Cₛ as the vehicle 10 proceeds across the field F, while the cutting disk 34 severs the upper portions Cᵤₚ of the sugarcane crop C for disposal. As the stalks Cₛ enter the harvested material divider 38, the ground shoes 42 may set an operating width to determine the quantity of sugarcane entering a throat of the vehicle 10. The spiral feed rollers 40 then gather the stalks Cₛ into the throat to allow the knock-down roller 44 to bend the stalks Cₛ downwardly in conjunction with the action of the fin roller 46. Once the stalks Cₛ are angled downward as shown in FIG. 1, the base cutter assembly 50 may then sever the base of the stalks Cₛ from field F. The severed stalks Cₛ are then, by the movement of the vehicle 10, directed to the feed roller assembly 52.

The severed sugarcane stalks Cₛ are conveyed rearwardly by the bottom and top rollers 54, 56, which compresses the stalks Cₛ, making them more uniform, and shakes loose debris 64 to pass through the bottom rollers 54 to the field F. At the downstream end portion of the feed roller assembly 52, the chopper assembly 58 cuts or chops the compressed sugarcane stalks Cₛ into pieces or billets 60 (e.g., 6-inch cane sections). The processed harvested material discharged from the chopper assembly 58 is then directed as a stream of billets 60 and debris 64 into the primary extractor 66. The airborne debris 64 (e.g., dust, dirt, leaves, etc.) separated from the billets 60 is then extracted through the primary extractor 66 using suction created by the extractor fan 68. The separated/cleaned billets 60 may then be directed to an elevator hopper 96 into the elevator assembly 62 and travel upwardly via the elevator 74 from its proximal end portion 76 to its distal end portion 78. Once the billets 60 reach the distal end portion 78 of the elevator 74, the billets 60 fall through the elevator discharge opening 94 to an external storage device. If provided, the secondary extractor 90 (with the aid of the extractor fan 92) blows out trash/debris 64 from the vehicle 10, similar to the primary extractor 66.

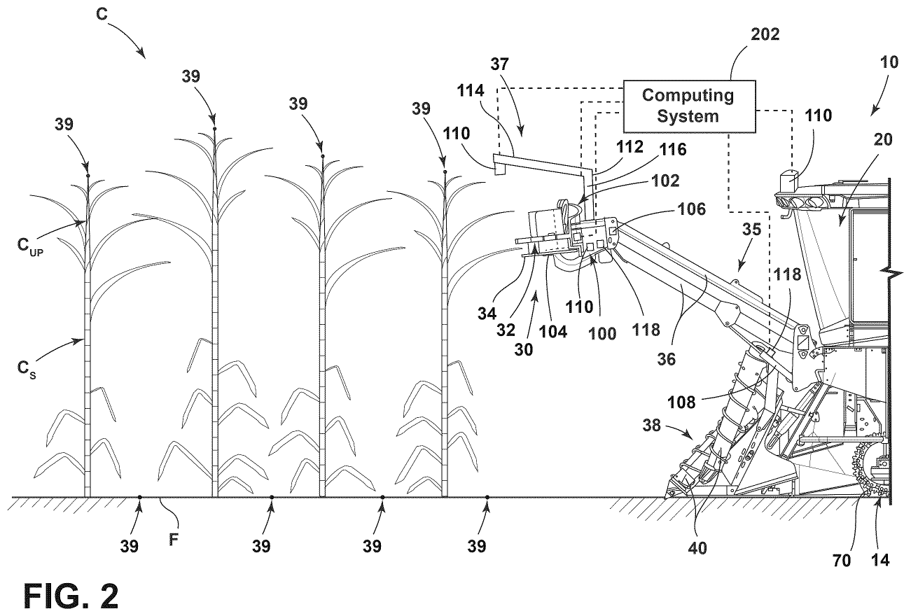

Referring now to FIG. 2, a side view of a portion of the vehicle 10 within a field F is illustrated in accordance with aspects of the present subject matter. As shown in FIG. 2, the topper assembly 30 may include a frame 100 and a deflector 102. The topper assembly 30 may further include a pair of gathering disks 32 and/or a cutting disk 34 positioned on an opposing side of the deflector 102 from the cab 20 of the vehicle 10. The gathering disk 32 may be configured to gather the sugarcane stalks Cₛ so that the cutting disk 34 may be used to cut off an upper portion Cᵤₚ of each stalk Cₛ. As illustrated, each of the pair of gathering disks 32 and/or a cutting disk 34 may be operably coupled with an actuation device 104, such as a motor, which may be hydraulically powered, pneumatically powered, electrically powered, and/or powered through any other source. Each pair of gathering disks 32 and/or a cutting disk 34 may be respectively coupled with independent actuation devices 104. Alternatively, any pair of gathering disks 32 and/or a cutting disk 34 may share a common actuation device 104.

The topper assembly 30 may be operably coupled with the remaining portions of the vehicle 10, such as the frame 12, through an adjustment assembly 35. The adjustment assembly 35 may include one or more arms 36 and/or one or more topper actuators 108. The one or more topper actuators 108 may be hydraulically powered, pneumatically powered, electrically powered, and/or powered through any other source for moving the topper assembly 30 between a plurality of positions relative to the field F.

In some examples, a sensor system 37 may include one or more field sensors 110 that may be operably coupled with the topper assembly 30, the adjustment assembly 35, and/or any other component of the vehicle 10 (e.g., the cab 20 of the vehicle 10). In some instances, the one or more field sensors 110 may be configured to capture data indicative of a distance from a target 39 (e.g., an upper region or a tip of the leaves and/or terrain along which the vehicle 10 traverses) to the one or more field sensors 110. In several examples, the one or more field sensors 110 may be configured as vision-based or wave-based sensors, such as cameras/imagers, radar sensors, ultrasound sensors, LIDAR devices, etc.

In various examples, a support 112 may be operably coupled with the frame 100 of the topper assembly 30. Alternatively, the support 112 may be integrally formed with the support 112, or any other component of the topper assembly 30. As illustrated, the support 112 can include a first portion 114 and a second portion 116 that is offset from the first portion 114. In some examples, the one or more field sensors 110 may be operably coupled with the support 112. However, the one or more field sensors 110 may be operably coupled with any other component of the topper assembly 30, and/or any other component of the vehicle 10 without departing from the scope of the present disclosure.

In various examples, the sensor system 37 can include an adjustment assembly sensor 118 that can be configured to monitor a position of the arms 36 and/or a component of the topper assembly 30. The topper assembly 30, the adjustment assembly 35, and/or the sensor system 37 may be operably coupled with a computing system 202. The computing system 202 may further be configured to receive an input related to a defined offset. The defined offset may be a defined height of the upper portion Cᵤₚ of the to-be-harvested crop C that is to be severed from the remaining stalks Cₛ. Additionally or alternatively, based at least in part on data received from the adjustment assembly sensor 118, the computing system 202 may be configured to determine a height of the one or more field sensors 110 operably coupled with the topper assembly relative to the field F. In turn, the computing system 202 may be configured to determine terrain variations based at least in part on the height of the one or more field sensors 110 relative to the field F.

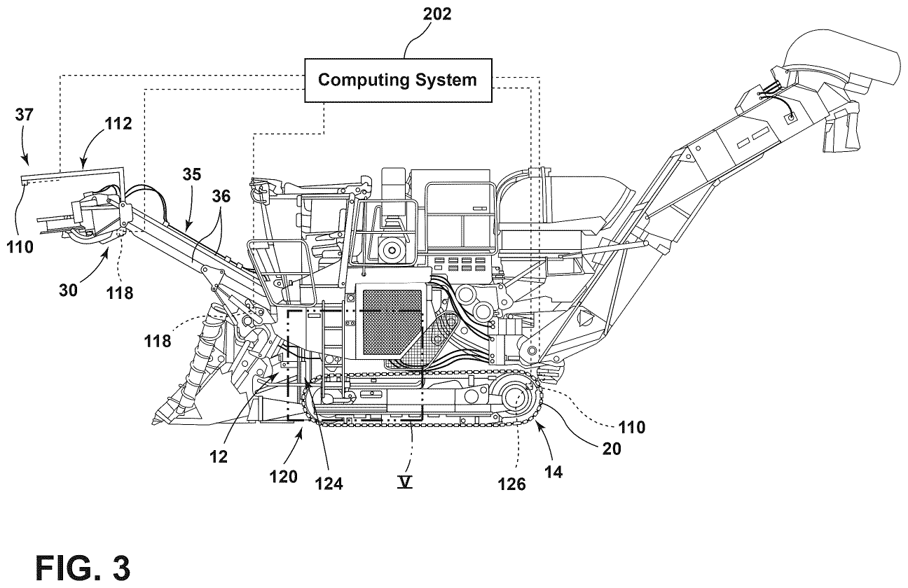

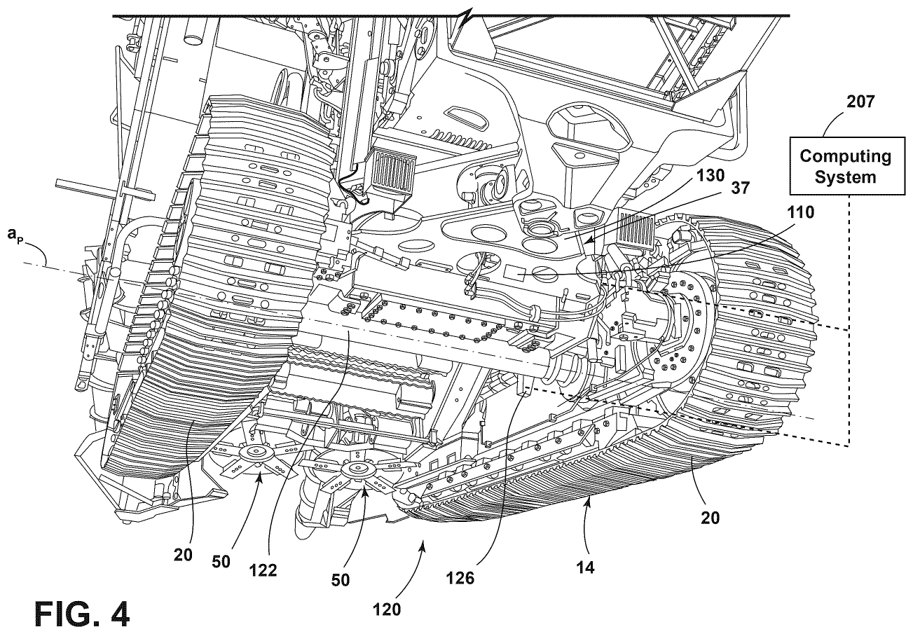

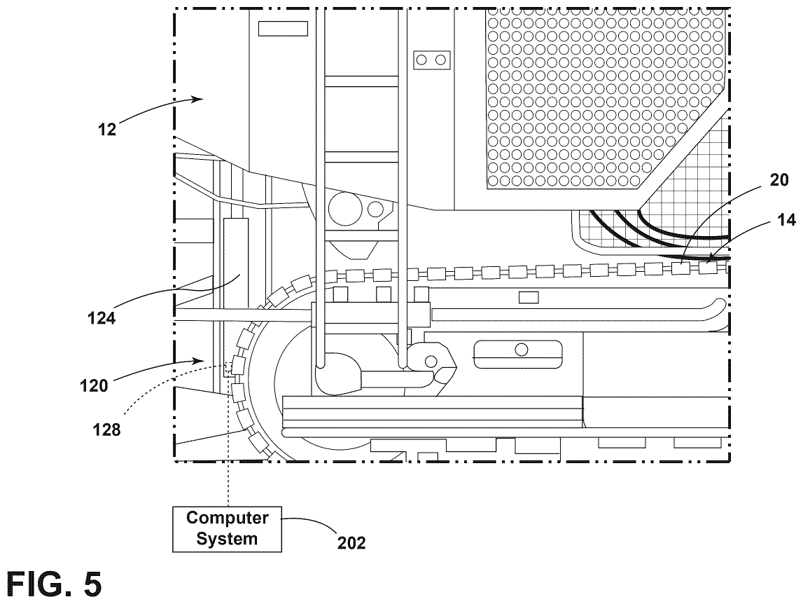

Referring now to FIGS. 3-5, a side view of the vehicle 10, a perspective bottom view of the vehicle 10, and an enhanced view of area V of FIG. 3 are respectively illustrated in accordance with aspects of the present subject matter. In the illustrated examples, the vehicle 10 may include a vehicle height control system 120 that allows for movement of one or more components of the vehicle 10 relative to the field F. For example, the vehicle height control system 120 may include a pivot axle 122 that may allow for rotation of the one or more components of the vehicle 10 about a pivot axis ap of rotation of the pivot axle 122.

Moreover, the vehicle height control system 120 may also include a height control actuator 124 that is operably coupled with the frame 12 of the vehicle 10 and the tractive assembly 14. When the height control actuator 124 extends thereby increasing its total length, the frame 12 rotates relative to the tractive assembly 14 about the pivot axis ap causing a forward portion of the vehicle 10 to be raised relative to the field F. When the height control actuator 124 retracts thereby shortening its total length, the frame 12 rotates relative to the tractive assembly 14 about the pivot axis ap causing a forward portion of the vehicle 10 to be raised relative to the field F. It will be appreciated, however, that the vehicle height control system 120 may be configured in any other practicable manner such that the frame 12 of the vehicle 10 may be adjusted relative to the tractive assembly 14. In various examples, various components of the harvested material processing system 28 may be operably coupled with the frame 12 of the vehicle 10. Accordingly, as the height control actuator 124 alters its length, the various components of the harvested material processing system 28 are repositioned relative to the tractive assembly 14 and/or the field F.

With further reference to FIGS. 3-5, the sensor system 37 may include a height control sensor 126 proximate to the pivot axle 122. In various examples, the height control sensor 126 may be configured to capture data indicative of a magnitude of movement of the frame 12 about the pivot axis ap. Moreover, the sensor system 37 may additionally or alternatively include a height control actuator sensor 128 that is configured to detect a position of an extension section of the height control actuator 124 relative to a base section of the height control actuator 124.

Additionally or alternatively, the sensor system 37 may further include a second field sensor 110, which may be remotely positioned from the topper assembly 30. For instance, the second field sensor 110 may be operably coupled with the vehicle 10 in a position that is aft of the pivot axis ap. In such examples, the second field sensor 110 may be operably coupled with an elevator bracket 130, and/or any other component of the vehicle 10.

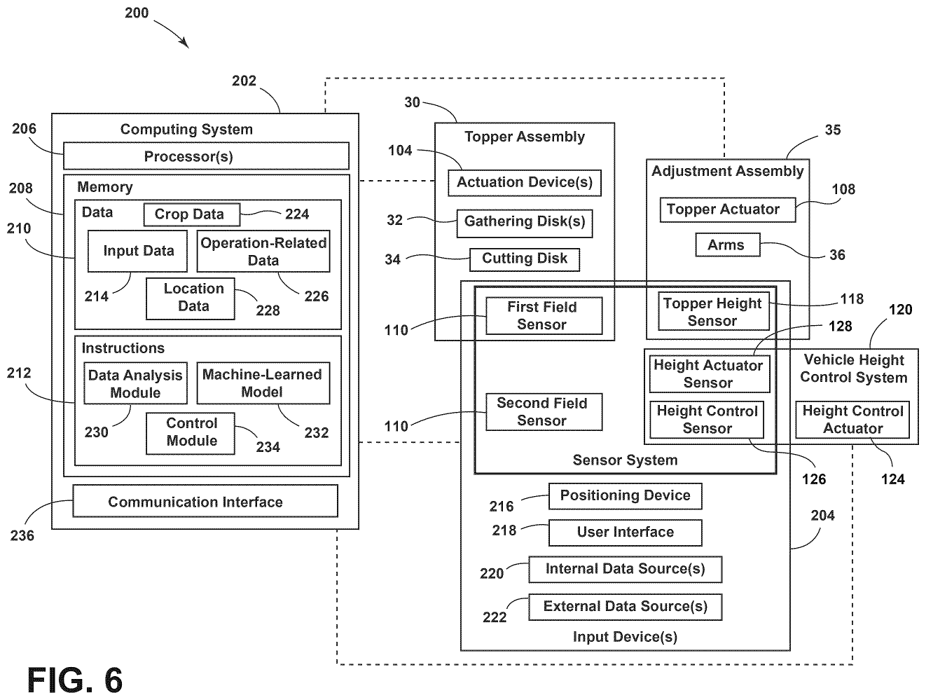

Referring now to FIG. 6, a schematic view of a system 200 is illustrated in accordance with aspects of the present subject matter. In general, the system 200 will be described herein with reference to the vehicle 10 described above with reference to FIGS. 1-5. However, it will be appreciated that the disclosed system 200 may generally be utilized with vehicles having any suitable vehicle configuration.

In several examples, the system 200 may include a computing system 202 and various other components configured to be communicatively coupled to and/or controlled by the computing system 202, such as various input devices 204 and/or various components of the vehicle 10. In some examples, the computing system 202 can operate to determine a cutting position of the topper assembly 30 based at least partially on data captured by the sensor system 37 and, further, to initiate one or more control actions associated with a vehicle 10, such as by altering a height of a topper assembly 30 based on the defined cutting position. Additionally or alternatively, the computing system 202 can operate to determine a terrain variation of the field F based at least partially on data captured by the sensor system 37 and, further, to initiate one or more control actions associated with a vehicle 10, such as by altering a height a base cutter assembly 50 based on the defined terrain variation. In various instances, the computing system 202 is physically coupled to the vehicle 10. In other examples, the computing system 202 is not physically coupled to the vehicle 10 (e.g., the computing system 202 may be remotely located from the vehicle 10) and instead may communicate with the vehicle 10 over a wireless network.

In general, the computing system 202 may correspond to any suitable processor-based device(s), such as a computing device or any combination of computing devices. Thus, as shown in FIG. 6, the computing system 202 may generally include one or more processor(s) 206 and associated memory 208 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 208 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 208 may generally be configured to store information accessible to the processor(s) 206, including data 210 that can be retrieved, manipulated, created, and/or stored by the processor(s) 206 and instructions 212 that can be executed by the processor(s) 206.

In several examples, the data 210 may be stored in one or more databases. For example, the memory 208 may include an input database 214 for storing input data received from the one or more input devices 204. In some examples, the one or more input devices 204 may include the sensor system 37, one or more positioning device(s) 216 for generating position data associated with the location of the vehicle 10, one or more user interfaces 218 for allowing operator inputs to be provided to the computing system 202 (e.g., buttons, knobs, dials, levers, joysticks, touch screens, and/or the like), one or more other internal data sources 220 associated with the vehicle 10 (e.g., other devices, databases, etc.), one or more external data sources 222 (e.g., a remote computing device or server, including, for instance, a machine-learning computing system 202), and/or any other suitable one or more input devices. The data received from the one or more input devices 204 may, for example, be stored within the input database 214 for subsequent processing and/or analysis.

It will be appreciated that, in addition to being considered one or more input devices 204 that allow an operator to provide inputs to the computing system 202, the user interface 218 may also function as an output device. For example, the user interface 218 may be configured to allow the computing system 202 to provide feedback to the operator (e.g., visual feedback via a display or other presentation device, audio feedback via a speaker or other audio output device, and/or the like).

As shown in FIG. 6, the memory 208 may also include a crop-related database 224 for storing information or data associated with to-be-harvested crops C and/or the field F. For example, as indicated above, based on the data received from the one or more input devices 204, the computing system 202 may be configured to estimate or calculate a type of crop C to be harvested and/or a location/position of the crop C. The location/position of the crops C may include a height of the crops C, a position of the crops C relative to one another, a location of the crops C relative to a field F, a verticality of the crops C (e.g., whether crops are growing in a vertical duration and/or have fallen and are no longer in a generally vertical orientation). The data may then be stored within the crop-related database 224 for subsequent processing and/or analysis.

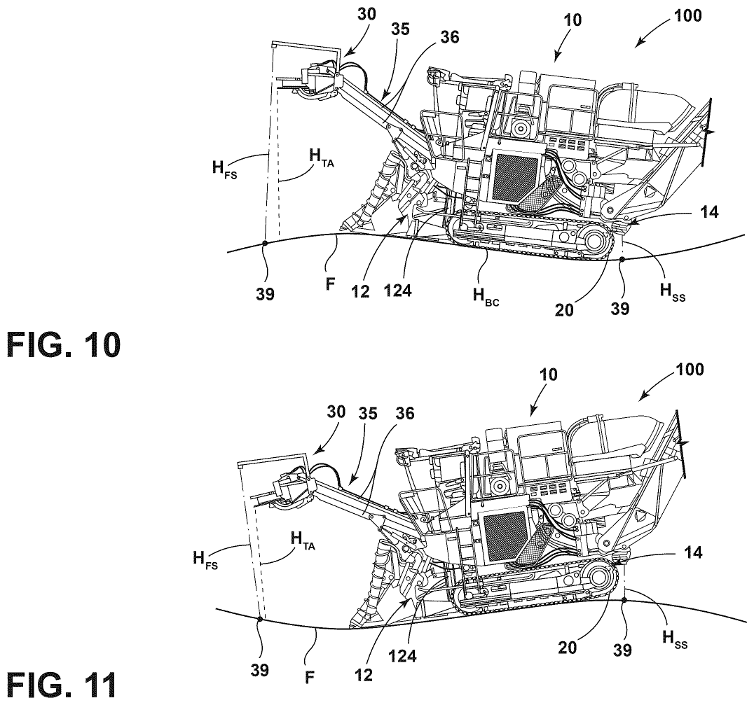

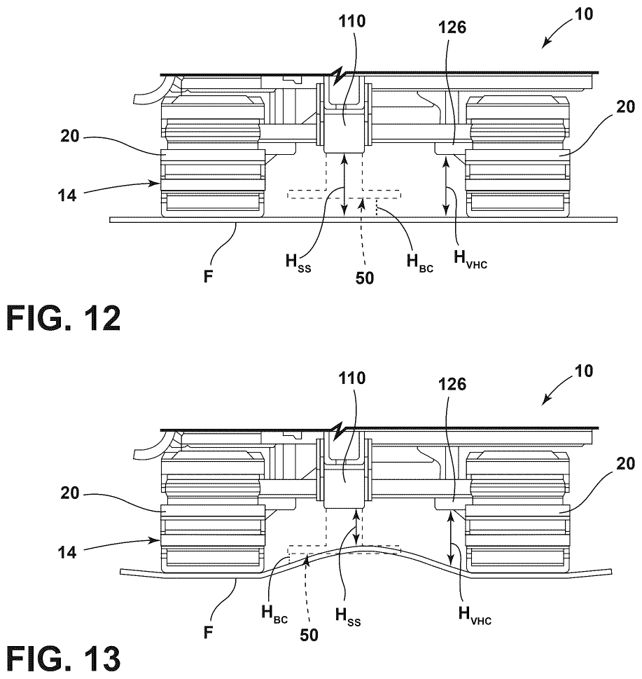

As shown in FIG. 6, the memory 208 may additionally or alternatively include a terrain database 226 for storing information or data associated with the terrain of the field F. For example, based on the terrain data received from the sensor system 37, the computing system 202 may be configured to determine one or more terrain variations, such as a ridge (e.g., incline in the field height) as shown in FIG. 9, a decline in the field height, an upcoming valley (e.g., decline in a field height) while traversing a ridge (e.g., an incline in the field height) as shown in FIG. 10, an upcoming ridge (e.g., incline in a field height) while traversing a valley (e.g., decline in the field height) as shown in FIG. 11, a lateral field height variance (as shown in FIGS. 12 and 13), and/or any other terrain variation. The terrain data may be stored within the operation-related database 226 for subsequent processing and/or analysis.

Additionally, as shown in FIG. 6, the memory 208 may include an operation-related database 226 for storing information or data associated with the harvest-related parameter(s) for the vehicle 10. For example, the operation-related database 226 may store data indicative of the vehicle height. The vehicle height may then be stored within the operation-related database 226 for subsequent processing and/or analysis.

Moreover, in several examples, the memory 208 may also include a location database 228 storing location information about the vehicle 10 and/or information about the field F being processed (e.g., a field map). Such location database 228 may, for example, correspond to a separate database or may form part of the input database 214. As shown in FIG. 6, the computing system 202 may be communicatively coupled to the positioning device(s) 216 installed on or within the vehicle 10. For example, in some examples, the positioning device(s) 216 may be configured to determine the exact location of the vehicle 10 using a satellite navigation position system (e.g., a GPS, a Galileo positioning system, the Global Navigation satellite system (GLONASS), the BeiDou Satellite Navigation and Positioning system, and/or the like). In such an example, the location determined by the positioning device(s) 216 may be transmitted to the computing system 202 (e.g., in the form of coordinates) and subsequently stored within the location database 228 for subsequent processing and/or analysis.

Additionally, in several examples, the location data stored within the location database 228 may also be correlated to all or a portion of the input data stored within the input database 214. For instance, in some examples, the location coordinates derived from the positioning device(s) 216 and the data received from the input devices 204 may both be time-stamped. In such an example, the time-stamped data may allow the data received from the input devices 204 to be matched or correlated to a corresponding set of location coordinates received from the positioning device(s) 216, thereby allowing the precise location of the portion of the field F associated with the input data to be known (or at least capable of calculation) by the computing system 202.

Moreover, by matching the input data to a corresponding set of location coordinates, the computing system 202 may also be configured to generate or update a corresponding field map associated with the field F being processed. For example, in instances in which the computing system 202 already includes a field map stored within its memory 208 that includes location coordinates associated with various points across the field F, the input data received from the input devices 204 may be mapped or correlated to a given location within the field map. Alternatively, based on the location data and the associated image data, the computing system 202 may be configured to generate a field map for the field F that includes the geo-located input data associated therewith.

Referring still to FIG. 6, in several examples, the instructions 212 stored within the memory 208 of the computing system 202 may be executed by the processor(s) 206 to implement a data analysis module 230. In general, the data analysis module 230 may be configured to analyze the data (e.g., a set of data received at a given time or within a given time period or a subset of the data, which may be determined through a pre-processing method) to determine a terrain variation. As provided herein, a terrain variation may be defined as a height variation in a vehicle fore-aft direction, a lateral direction, a combination thereof, and/or any other direction. As such, the terrain variation may be a ridge, a valley, and/or any other variation that may occur within a field F. In some instances, the data analysis module 230 can cooperatively operate with or otherwise leverage a machine-learned model 232 to analyze the data 224 to determine the terrain variation. In some examples, the machine-learned model 232 may include an algorithm that identifies the differences in the reflectivity or spectral absorption between the crop C and the field F contained within the data to filter terrain data from the crop data. In such instances, the terrain data may be analyzed to determine the terrain variations.

Additionally or alternatively, the data analysis module 230 may be configured to analyze the operation-related data (e.g., a set of operation-related data received at a given time or within a given time period or a subset of the operation-related data, which may be determined through a pre-processing method) to determine a vehicle height using any algorithm. In some instances, the data analysis module 230 can cooperatively operate with or otherwise leverage a machine-learned model 232 to analyze the operation-related data 226 to determine the vehicle height. Based on the vehicle height, the data analysis module 230 may determine a height/position of any component of the vehicle 10, such as a component of the harvested material processing system 28.

Referring still to FIG. 6, the instructions 212 stored within the memory 208 of the computing system 202 may also be executed by the processor(s) 206 to implement a control module 234. The control module 234 may be configured to actuate a vehicle height control system 120 that allows for movement of one or more components of the vehicle 10 relative to the field F. For example, the vehicle height control system 120 may include a pivot axle 122 (FIGS. 3-5) that allows for rotation of the one or more components of the vehicle 10 about a pivot axis of rotation of the pivot axle 122 (FIGS. 3-5) when the control module 234 activates a height control actuator 124. Thus, the system 200 can detect terrain variations and proactively and/or reactively adjust the vehicle 10 to account for the terrain variations.

Additionally or alternatively, the control module 234 may be configured to adjust the position of the cutting disk 34 when the position of the cutting disk 34 is varied from a defined position by controlling one or more components of the adjustment assembly 35. In general, the cutting position is defined as a position along the crop C that is a defined offset below the target 39 of the crop C. Thus, the system 200 can detect a target 39 of the crop C and reactively adjust a position of the topper assembly 30 so that a generally common upper portion Cᵤₚ height is severed from the crop C.

As such, the system 200 may be configured to receive an input related to a defined offset or height of the base cutter assembly 50 relative to the field F, receive the terrain data from the sensor system 37, determine a terrain variation of the field F based on the terrain data, determine a detected position of the base cutter assembly 50 relative to the field F based on the detected terrain variation, the position of the height control actuator 124, and/or any other source. In turn, the system 200 may actuate the vehicle height control system 120 based on a variation between the defined height H_{BC} of the base cutter assembly 50 and a detected height H_{BC} of the base cutter assembly 50.

In some cases, the first field sensor 110 may be configured to capture data indicative of a first set of terrain data and the second field sensor 110 may be configured to capture data indicative of a second set of terrain data aft of the first set of terrain data. In such cases, the system 200 may determine the terrain variation based on a variation in the first set of terrain data or the second set of the terrain data from a defined first field sensor 110 height or a second field sensor 110 height based on the vehicle 10 operating on a flat section of the field F.

Moreover, as shown in FIG. 6, the computing system 202 may also include a communications interface 236 to communicate with any of the various other system components described herein. For instance, one or more communicative links or interfaces (e.g., one or more data buses and/or wireless connections) may be provided between the communications interface 236 and the one or more input devices 204 to allow data transmitted from the one or more input devices 204 to be received by the computing system 202. Additionally, as shown in FIG. 6, one or more communicative links or interfaces (e.g., one or more data buses and/or wireless connections) may be provided between the communications interface 236 and one or more electronically controlled components of the vehicle 10 to allow the computing system 202 to control the operation of such system components.

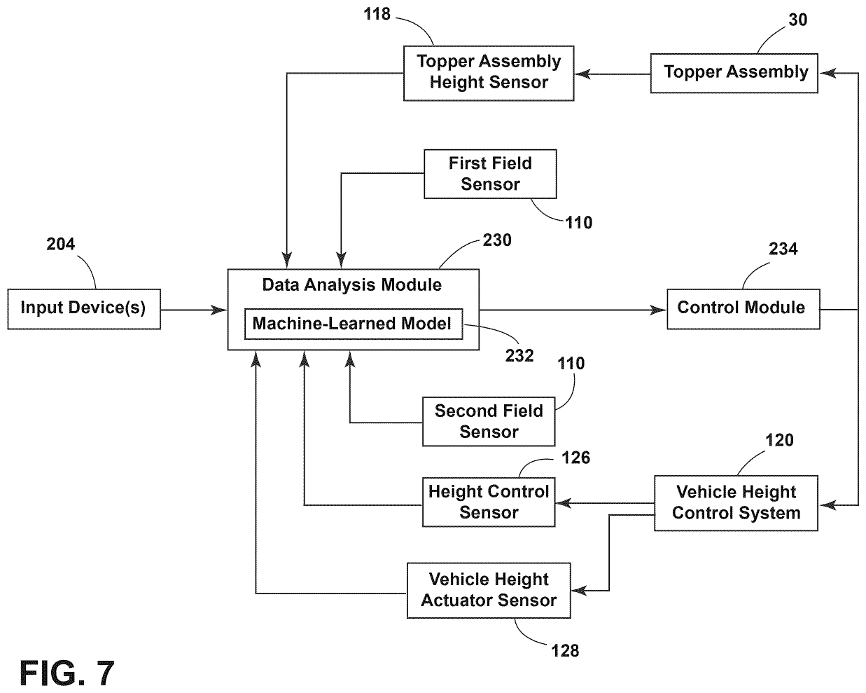

Referring now to FIG. 7, various components of the system 200 are illustrated in accordance with various aspects of the present disclosure. As illustrated in FIG. 7, the system 200 provided herein may provide closed-loop control for monitoring and/or generating one or more commands to alter one or more components of the vehicle 10 based on the received commands and/or received data. As shown, the data analysis module 230 may receive data 210 from various components of the system 200 and an inputted command. As provided herein, the data received from the various components may be provided to the data analysis module 230 and/or stored within the memory 208 (FIG. 6) before being provided to the data analysis module 230. The data analysis module 230 may receive the data and the input(s) and determine a target height H_{TA} of the topper assembly 30 and/or terrain variations within the field F. In turn, the system 200 may determine one or more control actions to adjust the height H_{TA} of the topper assembly 30 relative to the field F and/or a vehicle height relative to the field F.

In the illustrated example, an input may be received that is indicative of a defined topper operation and/or a defined cutting height of a crop relative to the field F, and/or any other defined operating parameter. The input may be provided to the data analysis module 230 from any source, such as the sensor system 37, one or more positioning device(s) for generating position data associated with the location of the vehicle 10, one or more user interfaces for allowing operator inputs to be provided to the computing system 202 (e.g., buttons, knobs, dials, levers, joysticks, touch screens, and/or the like), one or more other internal data sources associated with the vehicle 10 (e.g., other devices, databases, etc.), one or more external data sources (e.g., a remote computing device or server, including, for instance, a machine-learning computing system), and/or any other suitable one or more input devices.

The data analysis module 230 may also receive data from the topper assembly height sensor 118. The topper assembly height sensor 118 may be configured to provide data indicative of the height H_{TA} of the topper assembly 30 relative to the vehicle 10. In addition, a first field sensor 110, which may be operably coupled with the topper assembly 30, may provide data indicative of the height of the crop within the field F and/or a terrain of the field F forwardly of a base cutter assembly 50. A vehicle height control sensor 126 may be configured to provide data indicative of the height of the vehicle 10 relative to a pivot axle 122 (FIGS. 3-5) of the vehicle 10. In addition, a vehicle height control actuator sensor 128 may be configured to provide data indicative of a position of an actuation portion of the height control actuator 124 relative to a base portion of the height control actuator 124. A second field sensor 110 may be positioned rearward of the first field sensor 110 and configured to provide data indicative of a terrain of the field F rearwardly of the base cutter assembly 50.

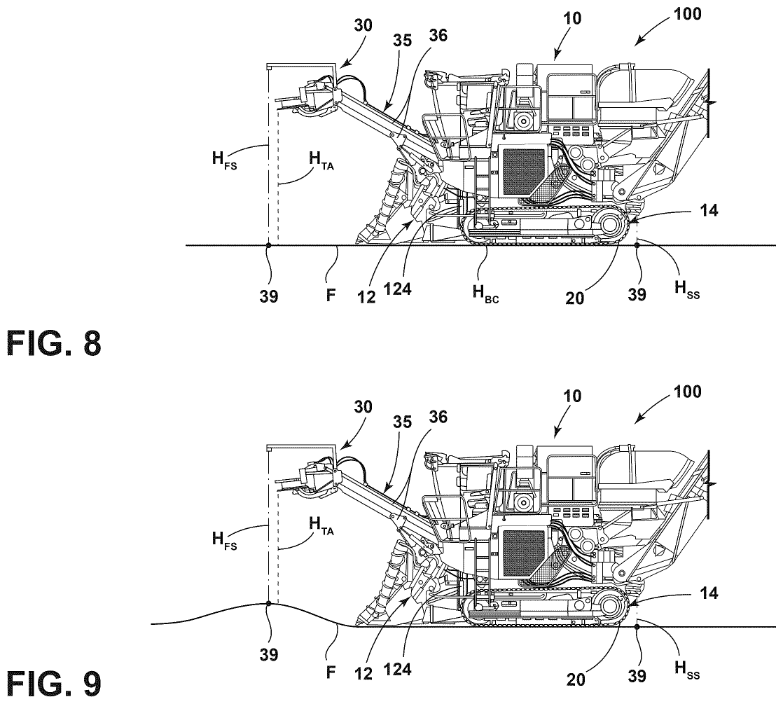

Based on the data received by the data analysis module 230 and the received input, the data analysis module 230 may determine a defined height of the vehicle 10 and/or the defined height H_{TA} of the topper assembly 30 to match the defined input(s). For instance, as shown in FIG. 8, as the vehicle 10 traverses a generally flat section of the field F with minimal terrain variations, the height H_{TA} of the topper assembly 30 relative to the vehicle 10 may be generally equal to a summation of the height H_{TA} of the topper assembly 30 and a height of the support 112 above the cutting disk 34 to define a first field sensor height H_{FS} relative to the field F. Moreover, the base cutter assembly 50 may be a height H_{BC} of the base cutter assembly 50 above the field F, and the second field sensor may be a second field sensor height H_{SS} above the field F. In such instances, the first field sensor height H_{FS} and the second field sensor height H_{SS} may each have a defined factor relative to one another based on their defined heights on a flat section of the field F with the topper assembly at a defined height.

However, as shown in FIG. 9, when the vehicle 10 approaches a terrain variation, such as an incline in the field F, one or more heights may vary from the defined factor, thereby indicating a change in terrain. For instance, as the vehicle 10 approaches the incline shown in FIG. 9, the first field sensor height H_{FS} and/or the height H_{TA} of the topper assembly 30 may be less than when the vehicle 10 is traversing a flat section of the field F. Moreover, as shown in FIG. 10, when the vehicle 10 approaches a terrain variation, such as a decline in the field F while traveling an incline, one or more heights may further vary from the defined factors, thereby indicating a change in terrain. For instance, as the vehicle 10 approaches the decline shown in FIG. 10, the first field sensor height H_{FS} and/or the height H_{TA} of the topper assembly 30 may be greater than when the vehicle 10 is traversing a flat section of the field F. Moreover, the second field sensor 110 may detect variations in its factor relative to the various other heights to further indicate the changes in terrain. Still further, as shown in FIG. 11, when the vehicle 10 approaches a terrain variation, such as an incline in the field F while traversing a decline, one or more heights may vary from the defined factors, thereby indicating a change in terrain. For instance, as the vehicle 10 approaches the incline shown in FIG. 11, the first field sensor height H_{FS} and/or the height H_{TA} of the topper assembly 30 may be less than when the vehicle 10 is traversing a flat section of the field F while the second field sensor 110 may detect a greater distance.

Furthermore, as shown in FIGS. 12 and 13, the system 200 may also detect lateral terrain variations. For example, when the vehicle 10 approaches a terrain variation, such as an incline in the field F in a lateral direction shown in FIG. 13, one or more heights may vary from the defined factors, thereby indicating a change in terrain. For instance, as the vehicle 10 approaches the lateral incline shown in FIG. 13, the second field sensor height H_{SS} may be less than the first field sensor 110 in a lateral direction.

As such, based on the various heights of the vehicle components relative to the field F and/or one another, the data analysis module 230 may be configured to determine terrain variations within the field F. In some cases, the defined height of the vehicle 10 and/or the defined height H_{TA} of the topper assembly 30 may be provided to the control module 234. The control module 234, in turn, may generate instructions for at least the topper assembly 30 and/or the vehicle height control system 120 to alter a component thereof.

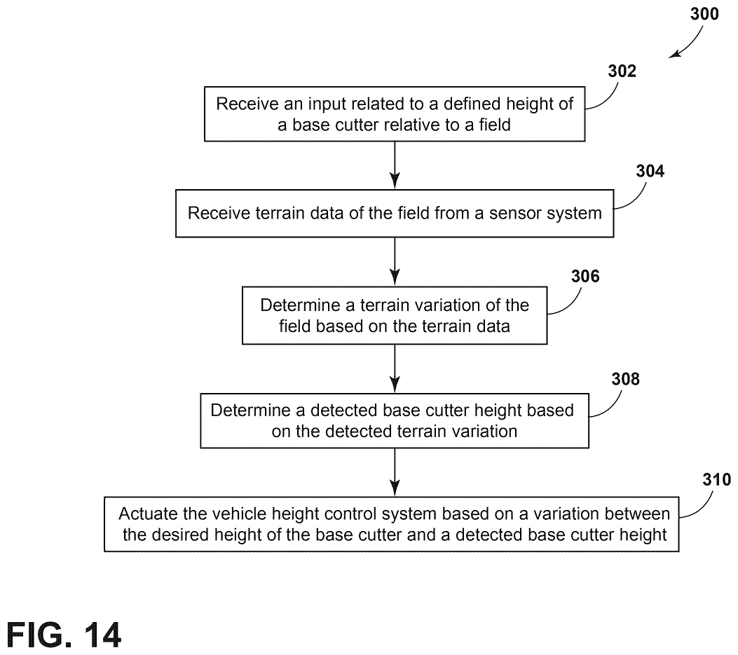

Referring now to FIG. 14, a flow diagram of a method 300 for operating an agricultural vehicle is illustrated in accordance with aspects of the present subject matter. In general, the method 300 will be described herein with reference to the agricultural vehicle 10 and related components described with reference to FIGS. 1-13. It will be appreciated, however, that the disclosed method 300 may be implemented with vehicles having any other suitable configurations and/or within systems having any other suitable system configuration. In addition, although FIG. 14 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 14, at (302), the method 300 may include receiving an input related to a defined offset of a base cutter assembly relative to a field. The input may be provided to the data analysis module from any source, such as the sensor system, one or more positioning device(s) for generating position data associated with the location of the vehicle 10, one or more user interfaces for allowing operator inputs to be provided to the computing system (e.g., buttons, knobs, dials, levers, joysticks, touch screens, and/or the like), one or more other internal data sources associated with the vehicle (e.g., other devices, databases, etc.), one or more external data sources (e.g., a remote computing device or server, including, for instance, a machine-learning computing system), and/or any other suitable one or more input devices.

At (304), the method 300 may include receiving terrain data of the field from a sensor system. In some cases, receiving terrain data of the field may include receiving a first set of terrain data from a first field sensor. Additionally, receiving terrain data of the field may also include receiving a second set of terrain data from a second field sensor, the second field sensor positioned aft of the first field sensor.

At (306), the method 300 may include determining a terrain variation of the field based on the terrain data with a computing system. In some cases, determining the terrain variation of the field based on the terrain data may include determining a variation in the first set of terrain data or the second set of the terrain data from a defined first field sensor height or a second field sensor height based on the vehicle operating on a flat section of the field. Moreover, determining the first field sensor height may be based at least partially on a height of the topper assembly.

At (308), the method 300 may include determining a detected position of the base cutter assembly relative to the field based on the detected terrain variation. In turn, the method 300, at (310), may include actuating the vehicle height control system based on a variation between the defined height of the base cutter assembly and a detected position of the base cutter assembly relative to the field. In some cases, the method 300 may include determining a magnitude of movement of a height control actuator. The actuation of the vehicle height control system further comprises activating the height control actuator based on the magnitude of movement.

In various examples, the method 300 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms may include computer-executable code that may be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural vehicle, the system comprising:
a base cutter assembly operably coupled with a frame, the base cutter assembly configured to sever a crop in a field;
a vehicle height control system configured to alter a position of the base cutter assembly;
a sensor system including a first field sensor configured to capture terrain data associated with a terrain of the field; and
a computing system including one or more processors and one or more non-transitory computer-readable media that collectively store instructions that, when executed by the one or more processors, configure the computing system to perform operations, the operations comprising:
receiving an input related to a defined offset of the base cutter assembly relative to the field;
receiving the terrain data from the sensor system;
determining a terrain variation of the field based on the terrain data;
determining a detected position of the base cutter assembly relative to the field based on the detected terrain variation; and
actuating the vehicle height control system based on a variation between a defined height of the base cutter assembly and a detected height of the base cutter assembly.

2. The system of claim 1, further comprising:
a topper assembly movably coupled with the frame through an adjustment assembly, the adjustment assembly including an adjustment sensor configured to capture data indicative of a position of the topper assembly relative to the field.

3. The system of claim 2, wherein the first field sensor is operably coupled with the topper assembly.

4. The system of claim 3, further comprising:
a support operably coupled with the topper assembly, the first field sensor operably coupled with the support and positioned at least partially forward of a cutting disk of the topper assembly.

5. The system of claim 1, further comprising:
an input device configured to provide the defined offset to the computing system.

6. The system of claim 1, wherein the vehicle height control system further comprises:
a pivot axle configured to allow for rotation of the frame relative to a tractive assembly about a pivot axis of rotation of the pivot axle.

7. The system of claim 6, wherein the vehicle height control system further comprises:
a height control actuator operably coupled with the frame of the vehicle and the tractive assembly and configured to rotate the frame relative to the tractive assembly about the pivot axis.

8. The system of claim 6, wherein the vehicle height control system further comprises:
a height control sensor proximate to the pivot axle and configured to capture data indicative of a magnitude of movement of the frame about the pivot axis.

9. The system of claim 1, further comprising:
a second field sensor positioned aft of the first field sensor, the second field sensor configured to capture terrain data associated with a terrain of the field rearward of the first field sensor.

10. A computer-implemented method for agricultural harvesting, the computer-implemented method comprising:
receiving an input related to a defined offset of a base cutter assembly relative to a field;
receiving, from a sensor system, terrain data of the field;
determining, with a computing system, a terrain variation of the field based on the terrain data;
determining a detected position of the base cutter assembly relative to the field based on the detected terrain variation; and
actuating a vehicle height control system based on a variation between a defined height of a base cutter assembly and a detected position of the base cutter assembly relative to the field.

11. The computer-implemented method of claim 10, further comprising:
determining a magnitude of movement of a height control actuator, wherein actuating the vehicle height control system further comprises activating the height control actuator based on the magnitude of movement.

12. The computer-implemented method of claim 10, wherein receiving, from a sensor system, terrain data of the field further comprises receiving a first set of terrain data from a first field sensor.

13. The computer-implemented method of claim 12, wherein receiving, from a sensor system, terrain data of the field further comprises receiving a second set of terrain data from a second field sensor, the second field sensor positioned aft of the first field sensor.

14. The computer-implemented method of claim 13, wherein determining the terrain variation of the field based on the terrain data further comprises determining a variation in the first set of terrain data or the second set of the terrain data from a defined first field sensor height or a second field sensor height based on the vehicle operating on a flat section of the field.

15. The computer-implemented method of claim 14, wherein determining the first field sensor height is based at least partially on a height of a topper assembly.

16. A system for an agricultural vehicle, the system comprising:
a base cutter assembly operably coupled with a frame, the base cutter assembly configured to sever a crop in a field;
a vehicle height control system including a height control actuator configured to alter a position of the base cutter assembly and the frame relative to a tractive assembly;
a sensor system including a first field sensor configured to capture data indicative of a first set of terrain data and a vehicle height control sensor configured to detect a position of the height control actuator; and
a computing system including one or more processors and one or more non-transitory computer-readable media that collectively store instructions that, when executed by the one or more processors, configure the computing system to:
receive an input related to a defined offset;
receive data from the sensor system;
determine a detected position of the base cutter assembly relative to the field based on the position of the height control actuator;
determine a terrain variation based on data from the first field sensor; and
actuate the vehicle height control system based on a variation between a defined height of the base cutter assembly and a detected height of the base cutter assembly.

17. The system of claim 16, wherein the sensor system further includes a second field sensor configured to capture data indicative of a second set of terrain data aft of the first set of terrain data, and wherein the computing system determines terrain variation based on a variation in the first set of terrain data or the second set of terrain data from a defined first field sensor height or a second field sensor height based on the vehicle operating on a flat section of the field.

18. The system of claim 16, wherein the first field sensor is operably coupled with a topper assembly.

19. The system of claim 17, wherein the vehicle height control system further comprises:
a pivot axle configured to allow for rotation of the frame relative to the tractive assembly about a pivot axis of rotation of the pivot axle.

20. The system of claim 19, wherein the first field sensor is positioned forwardly of the pivot axle and the second field sensor is positioned rearwardly of the pivot axle.
